(19) United States
(12) Patent Application Publication
(10) Pub. No.: US 2015/0349550 A1
(43) Pub. Date: Dec. 3, 2015

(54) METHOD AND APPARATUS FOR CELL BALANCING OF BATTERY MANAGEMENT SYSTEM

(71) Applicant: Samsung Electronics Co., Ltd., Suwon-si (KR)

(72) Inventor: Jinyong Jeon, Yongin-si (KR)

(73) Assignee: SAMSUNG ELECTRONICS CO., LTD., Suwon-si (KR)

(21) Appl. No.: 14/628,602

(22) Filed: Feb. 23, 2015

(30) Foreign Application Priority Data
May 30, 2014 (KR) 10-2014-0065956

(51) Int. Cl. H02J 7/00; B60L 11/18

(52) U.S. Cl. CPC H02J 7/0014; B60L 11/1866; H02J 7/0021

(57) ABSTRACT

A battery control apparatus includes resistors respectively connected to cells in battery modules, a temperature sensor configured to measure a temperature of the resistors, and a controller configured to control balancing performed on the cells based on the measured temperature.

### CROSS-REFERENCE TO RELATED APPLICATIONS

This application claims the benefit under 35 USC 119(a) of Korean Patent Application No. 10-2014-0065956 filed on May 30, 2014, in the Korean Intellectual Property Office, the entire disclosure of which is incorporated herein by reference for all purposes.

### BACKGROUND

1. Field

The following description relates to a method and an apparatus for cell balancing of a battery management system (BMS).

2. Description of Related Art

Recently, electric vehicles have attracted substantial attention as a future means of transportation while issues related to environment and energy resources are becoming more prominent. An electric vehicle uses, as a main power source, a battery in which chargeable and dischargeable secondary cells form a pack, and thus emits no exhaust and an associated amount of noise is to a large extent reduced.

However, deviations may occur between the cells in the battery at a time of manufacture. Among the deviations, a voltage deviation between the cells may be an important factor to determine an available charge and discharge capacity of the battery. Thus, a battery management system (BMS) may perform cell balancing to maintain the voltage deviation between the cells to be constant.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a battery control apparatus includes resistors respectively connected to cells in battery modules; a temperature sensor configured to measure a temperature of the resistors; and a controller configured to control balancing performed on the cells based on the measured temperature.

The resistors may be disposed based on an order of the battery modules and an order of the cells; and the temperature sensor may be further configured to measure the temperature of the resistors at a portion of the battery control apparatus at which the resistors are concentrated.

The apparatus may further include a voltage sensor configured to measure voltages of the cells; the controller may be further configured to calculate a voltage deviation between the cells from the measured voltages of the cells; and the controller may be further configured to perform the balancing on the cells in response to the voltage deviation being greater than a predetermined threshold voltage value.

The controller may be further configured to perform the balancing on the cells in response to the measured temperature being less than a predetermined first threshold temperature value.

The controller may be further configured to perform the balancing on the cells based on a balancing performance cycle, and increase the balancing performance cycle in response to the measured temperature being less than a predetermined second threshold temperature value.

The controller may be further configured to decrease the balancing performance cycle in response to the measured temperature being greater than or equal to the predetermined second threshold temperature value.

The controller may be further configured to classify the cells into groups, and perform the balancing on the cells one group at a time.

The controller may be further configured to classify cells in odd numbered battery modules of the battery modules into a first group of the groups, and classify cells in even numbered battery modules of the battery modules into a second group of the groups.

The controller may be further configured to classify a first cell of the cells into a first group of the groups, and classify a second cell adjacent to the first cell into a second group of the groups.

The controller may be further configured to classify odd numbered cells in odd numbered battery modules of the battery modules and even numbered cells in even numbered battery modules of the battery modules into a first group of the groups, and classify even numbered cells in the odd numbered battery modules and odd numbered cells in the even numbered battery modules into a second group of the groups.

The controller may be further configured to randomly classify the cells into the groups.

The controller may be further configured to classify remaining cells excluding a cell having a lowest voltage among the cells into the groups.

The controller may be further configured to apply electrical energy of remaining cells excluding a cell having a lowest voltage among the cells to resistors respectively connected to the remaining cells to during the balancing to cause voltages of the remaining cells to be equal to a voltage of the cell having the lowest voltage among the cells.

In another general aspect, a cattery control method includes measuring a temperature of resistors respectively connected to cells in battery modules; and controlling balancing performed on the cells based on the measured temperature.

The controlling may include calculating a voltage deviation between the cells by measuring voltages of the cells; and performing the balancing on the cells in response to the voltage deviation between the cells being greater than a predetermined threshold voltage value.

The controlling may further include performing the balancing on the cells in response to the measured temperature being less than a predetermined first threshold temperature value.

The controlling may further include increasing a length of a balancing performance cycle in which the balancing is performed on the cells in response to the measured temperature being less than a predetermined second threshold temperature value.

The controlling may further include decreasing the length of the balancing performance cycle in response to the measured temperature being greater than or equal to the predetermined second threshold temperature value.

In another general aspect, a non-transitory computer-readable storage medium stores instructions to cause a computer to perform the method described above.

In another general aspect, a battery control apparatus includes a cell balancing device configured to perform balancing on cells of a battery; a temperature sensor configured to measure a temperature of the cell balancing device; and a controller configured to control the cell balancing device to perform the cell balancing based on the measured temperature.

Other features and aspects will be apparent from the following detailed description, the drawings, and the claims.

### BRIEF DESCRIPTION OF THE DRAWINGS

FIG. 1 illustrates an example of a battery control apparatus.

FIG. 2 illustrates another example of a battery control apparatus.

FIG. 3 illustrates an example of resistors and temperature sensors.

FIGS. 4 and 5 illustrate examples of cell balancing.

FIG. 6 illustrates an example of a balancing performance cycle.

FIG. 7 illustrates an example of a battery control method.

FIG. 8 illustrate another example of a battery control method.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

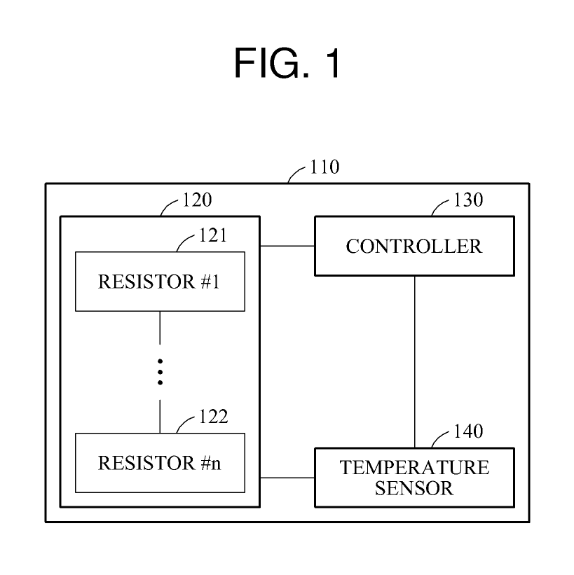

FIG. 1 illustrates an example of a battery control apparatus 110.

Referring to FIG. 1, the battery control apparatus 110 includes a resistor unit 120, a controller 130, and a temperature sensor 140. The battery control apparatus 110 controls a battery pack.

The battery pack may provide power to a transportation device, for example, an electric vehicle and an electric bicycle, provided with the battery pack, and includes battery modules. A battery module includes cells. The cells may be a secondary cell such as a lithium ion battery. Capacities or voltages of the cells may be the same or different.

The battery control apparatus 110 monitors a state of the battery pack and controls the battery pack. The battery control apparatus 110 may be referred to as a battery management system (BMS).

The battery control apparatus 110 controls a temperature of the battery modules in the battery pack. Also, the battery control apparatus 110 prevents overcharging and overdischarging of the battery modules and controls charge states of the battery modules to be the same. Accordingly, an energy efficiency of the battery modules will increase, and thus a lifespan of the battery modules will be prolonged.

The battery control apparatus 110 estimates a state of health (SoH) information, a state of charge (SoC) information, and a state of function (SoF) information associated with the battery modules. The SoH indicates a degree of deterioration in performance of the battery pack compared to performance at a time of manufacturing the battery pack. The SoC indicates an amount of charge received by the battery pack, and the SoF indicates whether the performance of the battery pack satisfies a predetermined condition.

The battery control apparatus 110 may provide the SoH, the SoC, and the SoF information to an electronic control unit (ECU). The battery control apparatus 110 may communicate with the ECU through controller area network (CAN) communication.

The resistor unit 120 includes resistors, for example, 121 and 122. The resistors 121 and 122 are respectively connected to the cells in the battery modules.

The controller 130 performs balancing on the cells. When charging and discharging are repeatedly performed on the cells, a voltage deviation may occur between the cells. When the voltage deviation occurs between the cells, a cell may be overcharged and overdischarged. When the cell is overcharged or overdischarged, a capacity of the battery pack and a lifespan of the battery pack may be reduced. The controller 130 performs the balancing on the cells using the resistor unit 120 to maintain the voltage deviation between the cells to be constant. For example, when the voltage deviation between the cells is greater than a predetermined threshold voltage value, the controller 130 may discharge cells having a relatively high voltage to allow voltages of all the cells to be equal. The controller 130 may apply electrical energy of remaining cells, excluding a cell having a lowest voltage among the cells, to resistors respectively connected to the remaining cells to discharge the remaining cells to cause voltages of the remaining cells to be equal a voltage of the cell having the lowest voltage among the cells. Accordingly, the voltages of the remaining cells will become equal to the voltage of the cell having the lowest voltage among the cells during the balancing.

When the balancing is performed on the cells, heat is generated in a resistor to which electrical energy is applied. The balancing performed on the cells may also be referred to as cell balancing. For example, when an excessive amount of heat is generated in the resistor, a performance of the resistor may decrease. The temperature sensor 140 measures a temperature of the resistor unit 120. When a measured temperature of the resistor unit 120 is less than a predetermined threshold temperature, the controller 130 performs the cell balancing. When a measured temperature of the resistor unit 120 is greater than or equal to the predetermined threshold temperature, the controller 130 suspends the cell balancing. Also, the controller 130 may change balancing conditions based on a temperature of the resistor unit 120. For example, the controller 130 may adjust a balancing performance cycle indicating a cycle in which the cell balancing is performed based on the temperature of the resistor unit 120. Accordingly, the temperature of the resistor unit 120 may be maintained to be constant.

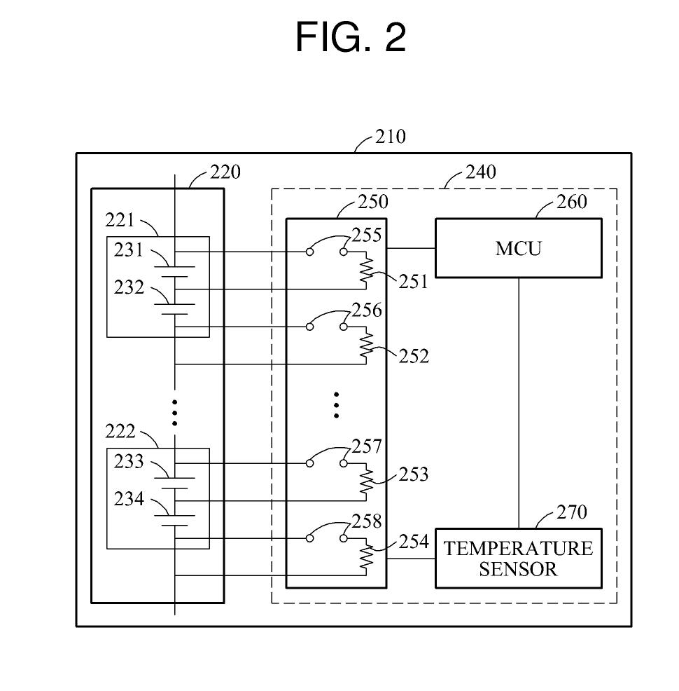

FIG. 2 illustrates another example of a battery control apparatus 240.

Referring to FIG. 2, a battery system 210 includes a battery pack 220 and the battery control apparatus 240.

The battery pack 220 includes battery modules, for example, 221 and 222. The battery module 221 includes cells, for example, 231 and 232, and the battery module 222 includes cells, for example, 233 and 234.

The battery control apparatus 240 includes a resistor unit 250, a controller 260, and a temperature sensor 270.

The resistor unit 250 includes resistors, for example, 251 through 254, and switches, for example, 255 through 258. The resistors 251 through 254 are respectively connected to the switches 255 through 258 and the cells 231 through 234. For example, the resistor 251 is connected to the cell 231 through the switch 255. Thus, when the switch 255 is in an on state, the cell 231 and the resistor 251 form a closed loop. The resistor unit 250 may be considered to be a cell balancing device. However, the cell balancing device is not limited to the resistor unit 250 having the particular configuration shown in FIG. 2, but may be any device known to one of ordinary skill in the art that is capable of selectively discharging individual ones of the cells 231 to 234.

In the example in FIG. 2, the controller 260 includes a micro control unit (MCU), but is not limited thereto, and may be any device known to one of ordinary skill in the art that is capable of performing the functions of the controller 260 as described herein. The controller 260 obtains voltage values of the cells 231 through 234 using a voltage sensor (not shown) to measure voltages of the cells 231 through 234. The voltage sensor may be included in the battery pack 220 or in the battery control apparatus 240. The controller 260 calculates a voltage deviation between the cells 231 through 234 using the voltage values of the cells 231 through 234. When the voltage deviation between the cells 231 through 234 is greater than or equal to a predetermined threshold voltage value, the controller 260 performs balancing on the cells 231 through 234. The controller 260 performs the balancing on the cells 231 through 234 based on a cell having a lowest voltage among the cells 231 through 234. For example, when a cell 232 of the cells 231 through 234 has a lowest voltage, the controller 260 turns on (i.e., closes) the switches 255, 257, and 258, and turns off (i.e., opens) the switch 256. Accordingly, electrical energy of the cell 231 is applied to the resistor 251, electrical energy of the cell 233 is applied to the resistor 253, and electrical energy of the cell 234 is applied to the resistor 254. When voltages of the cells 231, 233, and 234 become equal to the voltage of the cell 232, the controller 260 turns off the switches 255, 257, and 258.

When the balancing is performed on the cells 231 through 234, heat is generated in the resistors 251 through 254. The temperature sensor 270 measures a temperature of the resistors 251 through 254. The resistors 251 through 254 may be disposed based on an order of the battery modules 221 and 222 and an order of the cells 231 through 234. The temperature sensor 270 may measure a temperature of a portion at which the resistors 251 through 254 are concentrated.

In one example, the controller 260 controls the balancing on the cells 231 through 234 based on a temperature measured by the temperature sensor 270. When the measured temperature is less than a predetermined first threshold temperature value, the controller 260 performs the balancing on the cells 231 through 234. For example, when a temperature of a resistor is greater than or equal to 70° C., performance of the resistor may decrease. To maintain the performance of the resistor, the controller 260 may set the first threshold temperature value to be 70° C., and perform the balancing on the cells 231 through 234 when the measured temperature is less than 70° C.

In another example, the controller 260 performs the balancing on the cells 231 through 234 based on a balancing cycle. The balancing cycle includes a balancing performance cycle and a balancing pause cycle. The balancing performance cycle is a cycle in which the balancing is performed on the cells 231 through 234, and the balancing pause cycle is a cycle in which the balancing is not performed on the cells 231 through 234.

In another example, the controller 260 adjusts the balancing performance cycle based on the measured temperature. For example, when the measured temperature is less than a predetermined second threshold temperature value, the controller 260 increases a length of the balancing performance cycle and decreases a length the balancing pause cycle. Accordingly, a period of time used to perform the balancing on the cells 231 through 234 increases, so the balancing on the cells 231 through 234 is performed faster. Conversely, when the measured temperature is greater than or equal to the predetermined second threshold temperature value, the controller 260 decreases the length of the balancing performance cycle and increases the length of the balancing pause cycle. Accordingly, a period of time used to perform the balancing on the cells 231 through 234 decreases, so an amount of heat generated in the resistors 251 through 254 decreases.

In another example, the controller 260 classifies the cells 231 through 234 into groups, and performs the balancing on the cells 231 through 234 by each group. The controller 260 may classify the cells 231 through 234 into the groups based on a predetermined rule or at random. For example, when the cell 233 has a lowest voltage among the cells 231 through 234, the controller 260 classifies the remaining cells 231, 232, and 234, excluding the cell 233, into groups. The controller 260 may classify the cells 231 and 234 into a first group and the cell 232 adjacent to the cell 231 into a second group. The controller 260 performs the balancing by alternating the first group and the second group. That is, the controller 260 performs the balancing one group at a time by alternating among the groups. For example, if there are three groups, the controller may perform the balancing on the first group, then on the second group, then on the third group, or in any other order. During a first balancing performance cycle, the controller 260 turns the switches 255 and 258 on and turns the switch 256 off. During a second balancing performance cycle, the controller 260 turns the switch 256 on and turns the switches 255 and 258 off. Accordingly, electrical energy is not simultaneously applied to the adjacent resistors 251 and 252, and thus an amount of heat generated in the resistors 251 and 252 decreases.

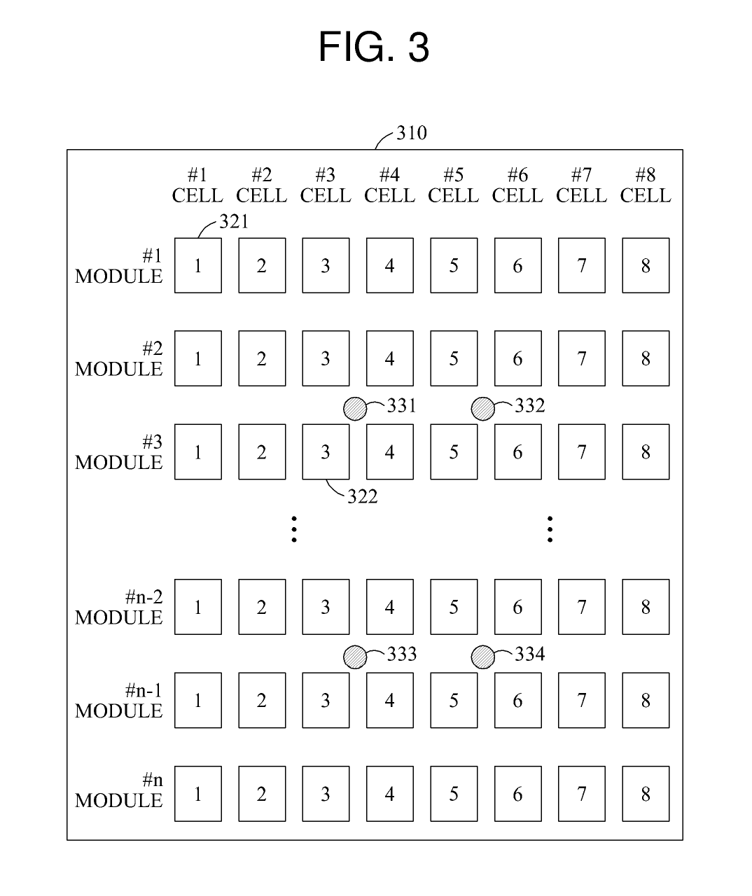

FIG. 3 illustrates an example of resistors and temperature sensors.

Referring to FIG. 3, a battery control apparatus 310 includes resistors (not shown) as described above in connection with FIG. 2. A battery pack includes battery modules, and each battery module includes cells. For example, the battery module may include eight cells.

The resistors are respectively connected to the cells in the battery pack. The resistors may be disposed in a printed circuit board (PCB). The resistors are disposed based on an order of the battery modules and an order of the cells. For example, when the number of the battery modules is “n,” and each of the n battery modules includes eight cells, each of n×8 resistors is connected to a corresponding cell. The n×8 resistors are laterally disposed based on an order of corresponding cells, and vertically disposed based on an order of a battery module in which each corresponding cell is included. When cell balancing is performed, electrical energy is applied to the resistors from the cells, and thus heat is generated in the resistors. When the heat is generated in the resistors, performances of the resistors decrease, and may even cause a fire in the PCB in which the resistors are disposed. Thus, the battery controller 310 measures a temperature of the resistors using the temperature sensors, and controls the cell balancing based on the measured temperature. A temperature of a portion at which resistors are most highly concentrated may be assumed to be a highest temperature. For example, a temperature of a resistor 322 around which resistors are disposed on all sides may be higher than a temperature of a resistor 321 around which resistors are not disposed on all sides. In the example illustrated in FIG. 3, temperature sensors, for example, 331 through 334, are disposed in a middle portion of the PCB at which resistors are most highly concentrated to measure a temperature of a resistor having a highest temperature among the resistors. Accordingly, the battery control apparatus 310 may control the cell balancing based on the temperature of the resistor having the highest temperature among the resistors.

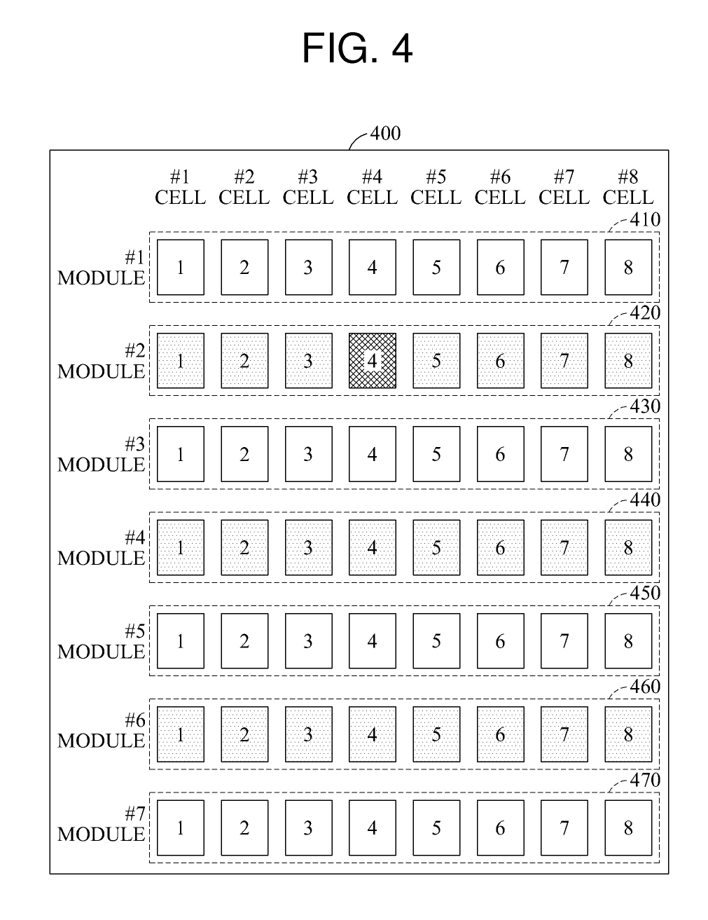

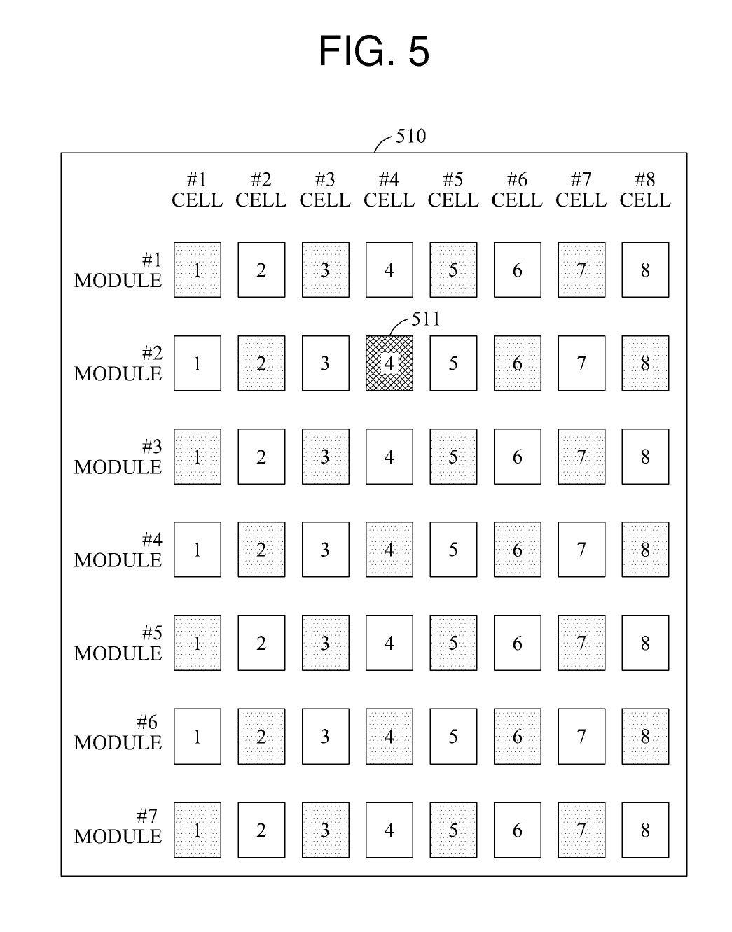

FIGS. 4 and 5 illustrate examples of cell balancing.

Referring to FIG. 4, a battery control apparatus 400 includes resistors. A battery pack includes battery modules, and each battery module includes cells. The resistors are respectively connected to the cells in the battery pack. The resistors are disposed based on an order of the battery modules and an order of the cells. For example, the resistors are vertically disposed based on an order of seven battery modules, and laterally disposed based on an order of eight cells in each one of the seven battery modules.

When cell balancing is performed, electrical energy is applied to the resistors from corresponding cells, and thus heat is generated. When electrical energy is continuously applied to the resistors during the cell balancing, a temperature of the resistors may rapidly increase. To prevent a rapid increase in the temperature of the resistors, the battery control apparatus 400 may classify the cells into groups and perform the cell balancing based on a group.

In one example, the battery control apparatus 400 classifies the cells into the groups based on a battery module. For example, the battery control apparatus 400 classifies cells in odd numbered battery modules among the battery modules into a first group, and cells in even numbered battery modules among the battery modules into a second group. However, when a cell in a battery module, for example, a fourth cell in a second battery module as indicated by the dark hatching in FIG. 4, has a lowest voltage among the cells, the fourth cell of the second battery module is excluded from the groups.

In this example, the battery control apparatus 400 performs the cell balancing by alternating the first group and the second group. Accordingly, when the cell balancing is being performed on the first group, electrical energy of the cells in the odd numbered battery modules is applied to resistors 410, 430, 450, and 470 respectively connected to the cells in the odd numbered battery modules. Similarly, when the cell balancing is being performed on the second group, electrical energy of the cells in the even numbered battery modules is applied to resistors 420, 440, and 460 respectively connected to the cells in the even numbered battery modules. Accordingly, electrical energy is not simultaneously applied to resistors, for example, the resistors 410 and 420, disposed in adjacent rows, and thus an amount of heat generated in the resistors 410 through 470 will decrease. Also, electrical energy is not applied to a resistor 420 connected to the fourth cell in the second battery module and having the lowest voltage among the cells, and thus voltages of the cells will become equal to the voltage of the fourth cell in the second battery module.

Referring to FIG. 5, a battery control apparatus 510 may classify cells into groups that are different from the groups in FIG. 4. In the example in FIG. 5, the battery control apparatus 510 classifies odd numbered cells in odd numbered battery modules and even numbered cells in even numbered battery modules into a first group. Also, the battery control apparatus 510 classifies even numbered cells in the odd numbered battery modules and odd numbered cells in the even numbered battery modules into a second group. However, when a cell in a battery module, for example, a fourth cell in a second battery module as indicated by the dark hatching in FIG. 5, has a lowest voltage among the cells, the fourth cell in the second battery module is excluded from the groups.

The battery control apparatus 510 performs cell balancing by alternating the first group and the second group. When the cell balancing is performed on the first group, electrical energy of corresponding cells is applied to resistors connected to the odd numbered cells in the odd numbered battery modules and the even numbered cells in the even numbered battery modules. When the cell balancing is performed on the second group, electrical energy of corresponding cells is applied to resistors connected to the even numbered cells in the odd numbered battery modules and the odd numbered cells in the even numbered battery modules. Accordingly, electrical energy is not simultaneously applied to adjacent resistors, and thus an amount of heat generated in the resistors will decrease. Also, electrical energy is applied to a resistor 511 connected to the fourth cell in the second battery module, and thus voltages of the cells will become equal to the voltage of the fourth cell in the second battery module.

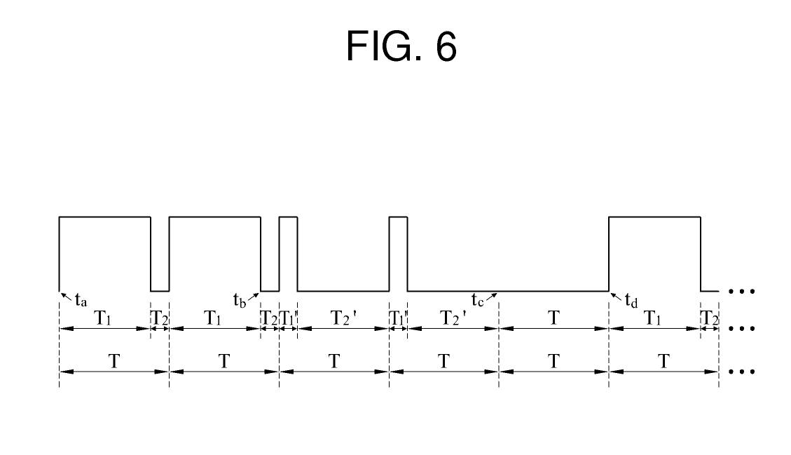

FIG. 6 illustrates an example of a balancing performance cycle.

Referring to FIG. 6, a battery control apparatus performs balancing on cells based on a balancing cycle. The battery control apparatus adjusts the balancing cycle based on a temperature of resistors connected to the cells. The balancing cycle includes a balancing performance cycle, which is a cycle in which cell balancing is performed, and a balancing pause cycle, which is a cycle in which the cell balancing is suspended.

The battery control apparatus measures the temperature of the resistors connected to the cells using a temperature sensor. When the measured temperature is less than a predetermined first threshold temperature, the battery control apparatus performs the cell balancing. Conversely, when the measured temperature is greater than or equal to the predetermined first threshold temperature, the battery control apparatus suspends the cell balancing. Also, when the measured temperature is less than a predetermined second threshold temperature, the battery control apparatus increases the balancing performance cycle and decreases the balancing pause cycle. Conversely, when the measured temperature is greater than or equal to the predetermined second threshold temperature, the battery control apparatus decreases the balancing performance cycle and increases the balancing pause cycle.

For example, at a point in time “tₐ,” when a voltage deviation between the cells is 1.5 volts (V), which is greater than a predetermined threshold voltage 1 V, and a temperature of the resistors connected to the cells is 20° C., which is less than a predetermined first threshold temperature 70° C., the battery control apparatus performs the cell balancing based on a balancing cycle “T,” a balancing performance cycle “T₁,” and a balancing pause cycle “T₂.” Accordingly, the battery control apparatus performs the cell balancing during a period of time corresponding to T₁, and suspends the cell balancing during a period of time corresponding to T₂.

In another example, at a point in time “t_{b},” when a temperature of the resistors is measured at 60° C., which is greater than a predetermined second threshold temperature 50° C., the battery control apparatus decreases the balancing performance cycle from T₁ to T₁′, and increases the balancing pause cycle from T₂ to T₂′. Accordingly, the battery control apparatus performs the cell balancing during a period of time corresponding to the balancing performance cycle T₁′, and suspends the cell balancing during a period of time corresponding to the balancing pause cycle T₂′.

In another example, at a point in time “t_{c},” when a temperature of the resistors is measured at 80° C., which is greater than the first threshold temperature 70° C., the battery control apparatus suspends the cell balancing.

In another example, at a point in time “t_{d},” when a temperature of the resistors is measured at 40° C., which is less than the second threshold temperature 50° C., the battery control apparatus once again performs the cell balancing based on the balancing performance cycle T₁ and the balancing pause cycle T₂.

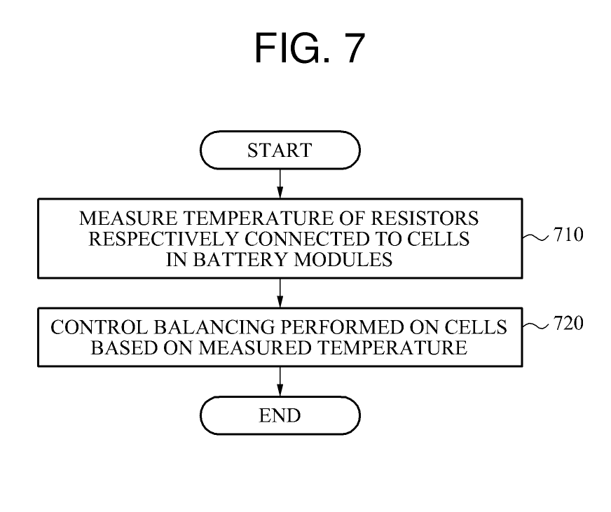

FIG. 7 illustrates an example of a battery control method.

Referring to FIG. 7, in 710, a battery control apparatus measures a temperature of resistors respectively connected to cells in battery modules.

In 720, the battery control apparatus controls balancing performed on the cells based on the measured temperature.

Descriptions provided with reference to FIGS. 1 through 6 are also applicable to FIG. 7, and thus repeated descriptions will be omitted here for brevity.

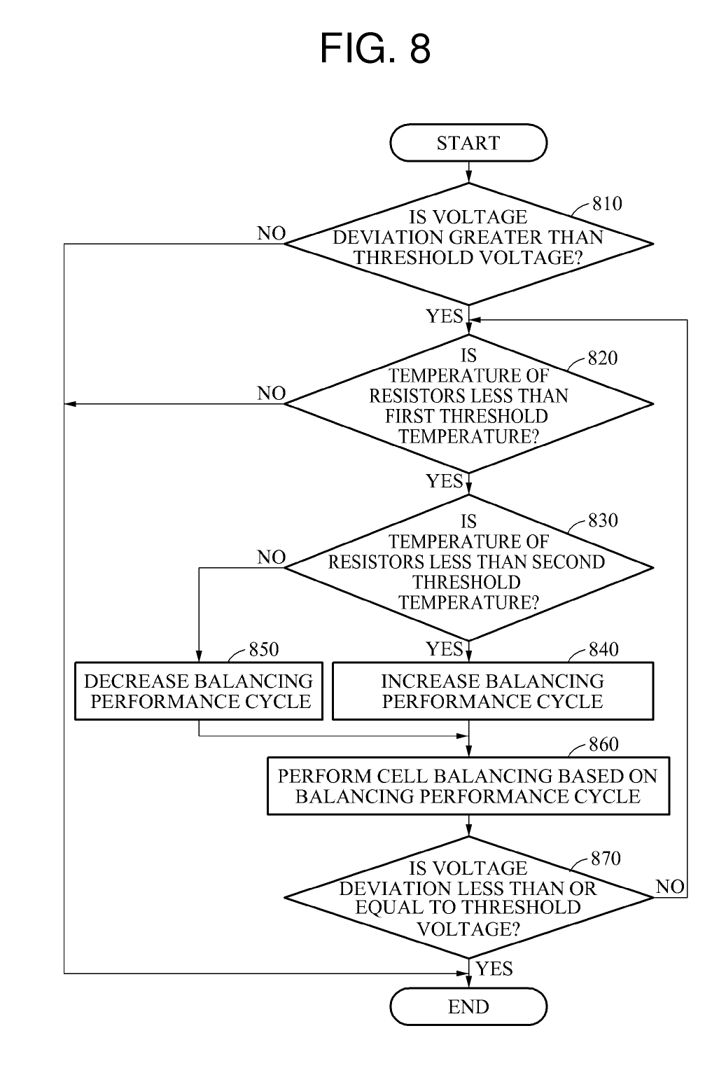

FIG. 8 illustrates another example of a battery control method.

Referring to FIG. 8, in 810, a battery control apparatus measures voltages of cells in each battery module in a battery pack, calculates a voltage deviation between the cells from the measured voltages of the cells, and compares the voltage deviation between the cells to a predetermined threshold voltage. When the voltage deviation is less than or equal to the threshold voltage, the battery control apparatus suspends balancing performed on the cells.

In 820, when the voltage deviation is greater than the threshold voltage, the battery control apparatus measures a temperature of resistors connected to the cells, and compares the measured temperature of the resistors to a predetermined first threshold temperature. When the temperature of the resistors is greater than or equal to the predetermined first threshold temperature, the battery control apparatus suspends the balancing performed on the cells.

In 830, when the temperature of the resistors is less than the predetermined first threshold temperature, the battery control apparatus compares the temperature of the resistors to a predetermined second threshold temperature.

In 840, when the temperature of the resistors is less than the predetermined second threshold temperature, the battery control apparatus increases a balancing performance cycle from a preset balancing performance cycle.

In 850, when the temperature of the resistors is greater than or equal to the predetermined second threshold temperature, the battery control apparatus decreases the balancing performance cycle from the preset balancing performance cycle.

In 860, the battery control apparatus performs the balancing on the cells based on the balancing performance cycle set in 840 or 850. The battery control apparatus applies electrical energy of remaining cells, excluding a cell having a lowest voltage among the cells, to discharge the remaining cells to cause voltages of the remaining cells to be equal to a voltage of the cell having the lowest voltage among the cells. Accordingly, the voltages of the remaining cells will become equal to the voltage of the cell having the lowest voltage among the cells during the balancing.

In 870, the battery control apparatus by measuring measures the voltages of the cells, calculates the voltage deviation between the cells and compares the voltage deviation to the predetermined threshold voltage. When the voltage deviation is greater than the threshold voltage, the battery control apparatus returns to 820. When the voltage deviation is less than or equal to the threshold voltage, the battery control apparatus suspends the balancing performed on the cells.

Descriptions provided with reference to FIGS. 1 through 6 are also applicable to FIG. 8, and thus repeated descriptions will be omitted here for brevity.

The controllers 130 and 260 in FIGS. 1 and 2 that perform the various operations described with respect to FIGS. 1-8 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Functional programs, codes, and code segments for implementing the examples disclosed herein can be easily constructed by a programmer skilled in the art to which the examples pertain based on the drawings and their corresponding descriptions as provided herein.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery control apparatus comprising:
resistors respectively connected to cells in battery modules;
a temperature sensor configured to measure a temperature of the resistors; and
a controller configured to control balancing performed on the cells based on the measured temperature.

2. The apparatus of claim 1, wherein the resistors are disposed based on an order of the battery modules and an order of the cells; and
the temperature sensor is further configured to measure the temperature of the resistors at a portion of the battery control apparatus at which the resistors are concentrated.

3. The apparatus of claim 1, further comprising a voltage sensor configured to measure voltages of the cells;
wherein the controller is further configured to calculate a voltage deviation between the cells from the measured voltages of the cells; and
the controller is further configured to perform the balancing on the cells in response to the voltage deviation being greater than a predetermined threshold voltage value.

4. The apparatus of claim 1, wherein the controller is further configured to perform the balancing on the cells in response to the measured temperature being less than a predetermined first threshold temperature value.

5. The apparatus of claim 1, wherein the controller is further configured to:
perform the balancing on the cells based on a balancing performance cycle; and
increase the balancing performance cycle in response to the measured temperature being less than a predetermined second threshold temperature value.

6. The apparatus of claim 5, wherein the controller is further configured to decrease the balancing performance cycle in response to the measured temperature being greater than or equal to the predetermined second threshold temperature value.

7. The apparatus of claim 1, wherein the controller is further configured to:
classify the cells into groups; and
perform the balancing on the cells one group at a time.

8. The apparatus of claim 7, wherein the controller is further configured to:
classify cells in odd numbered battery modules of the battery modules into a first group of the groups; and
classify cells in even numbered battery modules of the battery modules into a second group of the groups.

9. The apparatus of claim 7, wherein the controller is further configured to:
classify a first cell of the cells into a first group of the groups; and
classify a second cell adjacent to the first cell into a second group of the groups.

10. The apparatus of claim 7, wherein the controller is further configured to:
classify odd numbered cells in odd numbered battery modules of the battery modules and even numbered cells in even numbered battery modules of the battery modules into a first group of the groups; and
classify even numbered cells in the odd numbered battery modules and odd numbered cells in the even numbered battery modules into a second group of the groups.

11. The apparatus of claim 7, wherein the controller is further configured to randomly classify the cells into the groups.

12. The apparatus of claim 7, wherein the controller is further configured to classify remaining cells excluding a cell having a lowest voltage among the cells into the groups.

13. The apparatus of claim 1, wherein the controller is further configured to apply electrical energy of remaining cells excluding a cell having a lowest voltage among the cells to resistors respectively connected to the remaining cells to during the balancing to cause voltages of the remaining cells to be equal to a voltage of the cell having the lowest voltage among the cells.

14. A battery control method comprising:
measuring a temperature of resistors respectively connected to cells in battery modules; and
controlling balancing performed on the cells based on the measured temperature.

15. The method of claim 14, wherein the controlling comprises:
calculating a voltage deviation between the cells by measuring voltages of the cells; and
performing the balancing on the cells in response to the voltage deviation between the cells being greater than a predetermined threshold voltage value.

16. The method of claim 14, wherein the controlling further comprises performing the balancing on the cells in response to the measured temperature being less than a predetermined first threshold temperature value.

17. The method of claim 14, wherein the controlling further comprises increasing a length of a balancing performance cycle in which the balancing is performed on the cells in response to the measured temperature being less than a predetermined second threshold temperature value.

18. The method of claim 17, wherein the controlling further comprises decreasing the length of the balancing performance cycle in response to the measured temperature being greater than or equal to the predetermined second threshold temperature value.

19. A non-transitory computer-readable storage medium storing instructions to cause a computer to perform the method of claim 14.

20. A battery control apparatus comprising:
a cell balancing device configured to perform balancing on cells of a battery;
a temperature sensor configured to measure a temperature of the cell balancing device; and
a controller configured to control the cell balancing device to perform the cell balancing based on the measured temperature.
